(19) United States
(12) Patent Application Publication
(10) Pub. No.: US 2026/0266364 A1
(43) Pub. Date: Sep. 10, 2026

(54) CONCENTRIC BISTABLE DISCONNECT ACTUATOR

(71) Applicant: Valeo Kapec Co., Ltd., Daegu (KR)

(72) Inventors: Vijayakumar VELAYUDHAM, Auburn Hills, MI (US); Patrick LE-MOAL, Auburn Hills, MI (US); Sungchul LEE, Auburn Hills, MI (US)

(73) Assignee: Valeo Kapec Co., Ltd., Daegu (KR)

(21) Appl. No.: 19/073,388

(22) Filed: Mar. 7, 2025

(51) Int. Cl. F16H 48/34; B60K 17/35

(52) U.S. Cl. CPC F16H 48/34; B60K 17/3515

(57) ABSTRACT

A disconnect actuator system which includes a first connecting part concentrically arranged about an axis and configured to move axially along the axis, and a second connecting part concentrically arranged about the axis and positioned adjacent to the first connecting part along the axis. An actuator is concentrically arranged about the axis and positioned radially outside of the first connecting part. The actuator includes a rotating part concentrically arranged about the axis and configured to rotate about the axis relative to the first and second connecting parts, and a converter configured to convert rotational movement of the rotating part into linear movement of the first connecting part such that the first connecting part can connect and disconnect with the second connecting part.

### BACKGROUND OF THE INVENTION

### Field of the Invention

This application generally relates to an actuator system which connects and disconnects rotational parts, such as two shafts, and more particularly relates to an actuator system for connecting and disconnecting a power input to a secondary e-axle in a hybrid/xEV vehicle so that vehicle operation can be switched between 2-wheel drive and 4-wheel drive

### Description of the Related Art

A hybrid/xEV vehicle with an all-wheel drive (AWD) application has a powertrain that can provide power to both the primary and secondary axles. When a vehicle power demand decreases, the AWD system runs at low efficiency operating conditions. To improve a vehicle operation efficiency, one of the axles, such as the secondary axle that receives power from the battery, is disconnected from the corresponding wheels using an actuator system. In the design of actuator systems for hybrid/xEV vehicles there is a constant demand for more compact actuator systems with reduced electrical power requirements.

### SUMMARY OF THE INVENTION

Aspects of the present disclosure provide a low-cost bistable actuator which is relatively compact and energy efficient.
A first aspect (1) is directed to a disconnect actuator system which includes a first connecting part concentrically arranged about an axis and configured to move axially along the axis, and a second connecting part concentrically arranged about the axis and positioned adjacent to the first connecting part along the axis. An actuator is concentrically arranged about the axis and positioned radially outside of the first connecting part. The actuator includes a rotating part concentrically arranged about the axis and configured to rotate about the axis relative to the first and second connecting parts, and a converter configured to convert rotational movement of the rotating part into linear movement of the first connecting part such that the first connecting part can connect and disconnect with the second connecting part.
An aspect (2) includes the disconnect actuator system according to aspect (1), wherein the converter is a cam mechanism.
An aspect 3( ) includes the disconnect actuator system of aspect (2), wherein the cam mechanism includes a cam groove provided in the rotating part and which extends circumferentially about the axis, and a follower coupled to the groove and configured to move axially along the axis when the rotating part rotates about the axis.
An aspect (4) includes the disconnect actuator system according to aspect (1), wherein the actuator includes a stator, and a rotor disposed radially inward to the stator, wherein the cam groove is provided on a radially inner surface of the rotor.
An aspect 5) includes the disconnect actuator system according to aspect (4), wherein the rotor is configured to rotate in one direction so that the first connecting part connects with the second connecting part, and the rotor is configured to rotate in the other direction so that the first connecting part disconnects with the second connecting part.
An aspect (6) includes the disconnect actuator system according to aspect (5), wherein the first connecting part and the second connecting part are connected to each other by engagement of clutch teeth.
An aspect (7) includes the disconnect actuator system according to aspect (4), wherein the first connecting part includes a thrust plate having a first end coupled to the converter; and a sleeve coupled to a second end of the thrust plate, wherein the thrust plate and sleeve are configured to move axially when the rotating part is rotated.
An aspect (8) includes the disconnect actuator system according to aspect (1), further including a first shaft which defines the axis and rotates about the axis; and a second shaft positioned adjacent to the first shaft along the axis and configured to rotate about the axis, wherein the first connecting part is coupled to the first shaft, the second connecting part is coupled to the second shaft, and the actuator is configured to connect and disconnect the first and second shaft with each other.
An aspect (9) includes the disconnect actuator system according to aspect (8), wherein the first shaft includes a flange configured to stop axial movement of the first connecting part in a connected position of the first and second shaft.
An aspect (10) includes the disconnect actuator system according to aspect (1), further including a stop mechanism coupled to the first shaft and configured to stop axial movement of the first connecting part in a disconnected position of the first and second shaft.
Another aspect (11) includes a disconnect actuator system for an electric vehicle, including a first connecting part rotatably connected to a first shaft which rotates about an axis and is connected to wheels of the electric vehicle, wherein the first connecting part is configured to move axially along the axis. A second connecting part is rotatably connected to a second shaft, which is connected to an axle of the electric vehicle. An actuation part is coupled with the first connecting part through an engagement part, configured to move the first connecting part so that the first connecting part is connected and disconnected with the second connecting part, being concentric with the first connecting part and the second connecting part, and configured to rotate relative to the first and second connecting parts.
An aspect (12) includes the disconnect actuator system according to aspect (11), wherein the engagement part is a cam mechanism.
An aspect (13) includes the disconnect actuator system according to aspect (12), wherein the actuation part is a rotor disposed radially inward to the stator and including the engagement part.
An aspect (14) includes the disconnect actuator system according to aspect (13), wherein the cam mechanism includes a circumferential groove in an inner diameter of the rotor, and a roller preloaded in the groove and coupled to the first connecting part.
An aspect (15) includes the disconnect actuator system according to aspect (14), wherein the rotor is configured to rotate in a first direction so that the first connecting part connects with the second connecting part, and the rotor is configured to rotate a second direction opposite to the first direction so that the first connecting part disconnects with the second connecting part.
An aspect (16) includes the disconnect actuator system according to aspect (11), wherein the first shaft is connected to one of rear wheels (RW) of the electric vehicle, and the second shaft is connected to an Axle (secondary axle) and the other of the rear wheels (RW) of the electric vehicle.
Aspect (17) is directed to a differential lock actuator system which includes a first connecting part concentrically arranged about an axis and configured to move axially along the axis, and a second connecting part concentrically arranged about the axis and positioned adjacent to the first connecting part along the axis. An actuator is concentrically arranged about the axis and includes a rotating part concentrically arranged about the axis and configured to rotate about the axis relative to the first and second connecting parts, and a converter configured to convert rotational movement of the rotating part into linear movement of the first connecting part such that the first connecting part can connect and disconnect with the second connecting part.
Aspect (18) includes the differential lock actuator system of aspect (17), wherein the first connecting part is rotatably connected to a first shaft which rotates about an axis of the electric vehicle, and the second connecting part is rotatably connected to a second shaft which is connected to an axle of the electric vehicle. The actuator is coupled with the first connecting part through an engagement part, is configured to move the first connecting part so that the first connecting part is connected and disconnected with the second connecting part, is concentrically arranged with the first connecting part and the second connecting part, and is configured to rotate relative to the first and second connecting parts.
Aspect (19) includes the differential lock actuator system of aspect (17), wherein the actuator includes a stator, and a rotor disposed radially inward to the stator, wherein a cam groove is provided on a radially inner surface of the rotor.
Aspect (20) includes the differential lock actuator system of aspect (19), wherein the rotor is configured to rotate in one direction so that the first connecting part connects with the second connecting part, and the rotor is configured to rotate in the other direction so that the first connecting part disconnects with the second connecting part.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective sectional view of a concentric bistable disconnect actuator system on a linking shaft in accordance with an example embodiment of the disclosure;

FIG. 2 is a longitudinal sectional view of the concentric bistable disconnect actuator system of FIG. 1;

FIG. 3 is a partial longitudinal sectional view of the concentric bistable disconnect actuator system of FIG. 1;

FIG. 4A is a perspective view of a movable clutch assembly in accordance with an example embodiment of the disclosure;

FIG. 4B is another perspective view of the movable clutch assembly of FIG. 4A;

FIG. 5A is a perspective view of a rotor in accordance with an example embodiment of the disclosure;

FIG. 5B is a side view of the rotor of FIG. 5A.

FIG. 6A is a perspective view of a portion of a concentric bistable disconnect actuator system in an engaged position in accordance with an example embodiment of the disclosure;

FIG. 6B is a perspective view of a portion of a concentric bistable disconnect actuator system in a disengaged position assembly in accordance with an example embodiment of the disclosure;

FIG. 7 is a partial perspective view of a rotor in accordance with an example embodiment of the disclosure;

FIG. 8 is a longitudinal sectional view of a concentric bistable disconnect actuator system on a differential in accordance with an example embodiment of the disclosure;

FIG. 9 is an enlarged partial sectional view of the concentric bistable disconnect actuator system of FIG. 8;

FIG. 10 illustrates an exemplary flowchart for performing connecting and disconnecting the movable clutch from the fixed fear according to one example embodiment of the present disclosure;

FIG. 11 is a longitudinal sectional view of a bistable actuator used as a differential locker according to one example embodiment of the present disclosure.

### DETAILED DESCRIPTION OF THE PREFERRED EMBODIMENTS

Referring now to the drawings, wherein like reference numerals designate identical or corresponding parts throughout the several views.

Reference will now be made in detail to exemplary embodiments and methods of the application as illustrated in the accompanying drawings, in which like reference characters designate like or corresponding parts throughout the drawings. It should be noted, however, that the application in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. Additionally, the word “a” and “an” as used in the claims means “at least one” and the word “two” as used in the claims means “at least two”.

As noted in the Background, there is a constant demand for more compact actuator systems with reduced electrical power requirements. A concentric mono stable disconnect system actuated by a solenoid motor is known. Such a solenoid actuated system is stable in one state (e.g., the disconnected position) but requires continuous power in the other state (e.g., connected position). The present inventors have recognized that while the mono stable disconnect system is relatively compact, the requirement for continuous power to maintain one state of the actuator is inefficient. To reduce power consumption, bistable actuator systems use power only to engage and disengage components and provide a stable condition in both connected and disconnected positions. Some bistable actuators use either a magnet or two solenoids to engage and disengage the actuator. The present inventors have recognized, however, that such systems are complex and expensive. Bistable off-axis disconnect systems also exist but occupy a substantial amount of space within a vehicle.

Disclosed herein is a low-cost bistable actuator system which is compact and energy efficient. A disconnect actuator system has various applications, such as on a linking shaft or differential. Generally, a disconnect actuator system includes a motor which includes a stator and a rotor disposed radially inward to the stator, a movable clutch, and a fixed gear. The movable clutch and the fixed gear are rotatably connected to a respective shaft in a linking shaft configuration. A cam mechanism between the rotor and the movable clutch moves a sleeve of the movable clutch to rotatably connect and disconnect the movable clutch with the fixed gear.

Such an actuator system provides the motor and the disconnected part in concentric arrangement making the disconnect actuator system compact while also providing two stable states for the actuator.

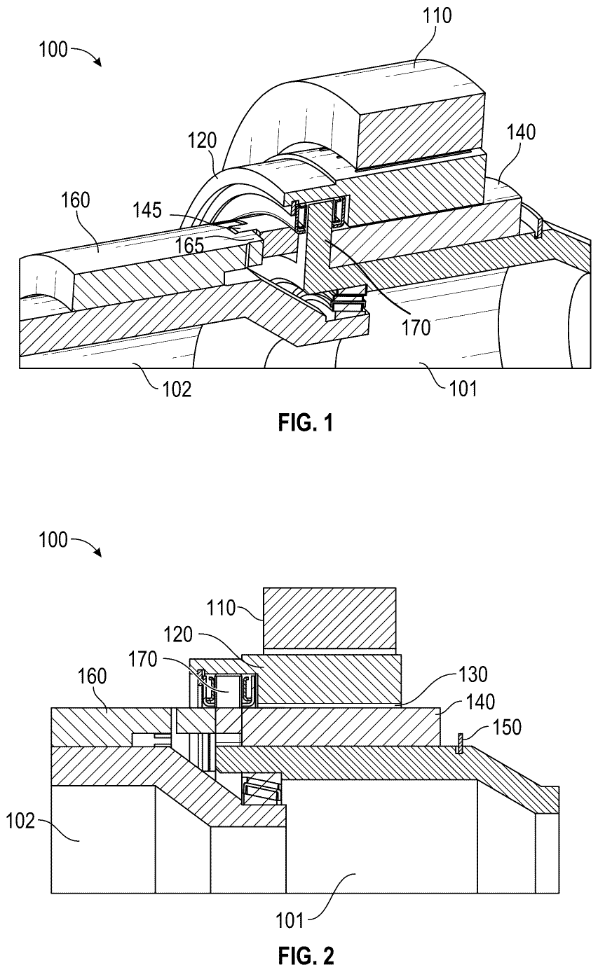

FIGS. 1 and 2 show a concentric bistable disconnect actuator system 100 provided on a linking shaft. The linking shaft includes a first shaft 101 and a second shaft 102, which can be rotated together or rotated separately depending on whether they are linked by the actuator system 100. The first shaft 101 and the second shaft 102 are concentric on an axis.

An induction motor is provided on the first shaft 101. The induction motor includes a stator 110 which is stationary, a rotor 120 which is disposed radially inward to the stator 110, and a movable clutch 140 positioned radially inward of the rotor 120. A cam mechanism 130 is provided at an interface of the rotor 120 and movable clutch 140 as shown in FIG. 2. In the illustrated embodiment, the cam mechanism 130 is implemented as a barrel cam groove and follower that translates rotational movement into linear movement as discussed further below. Any suitable mechanism, such as a screw interface, may be used to translate rotational movement of the rotor to linear movement along the shafts.

The movable clutch 140 includes, for example, a dog clutch slider. The movable clutch 140 is connected and disconnected with a fixed gear 160 which is rotatably connected to the second shaft 102 and includes a fixed dog gear. Linear motion of the movable clutch 140 is limited by clutch stopper 150 and flange 170 provided on the first shaft as shown in FIG. 2.

The movable clutch 140 and the fixed gear 160 are rotatably connected to the first and second shaft respectively. When the movable clutch 140 is connected with the fixed gear 160, the first shaft 101 and the second shaft 102 are rotated together. When the movable clutch 140 is disconnected from the fixed gear 160, the first shaft 101 and the second shaft 102 are rotated separately.

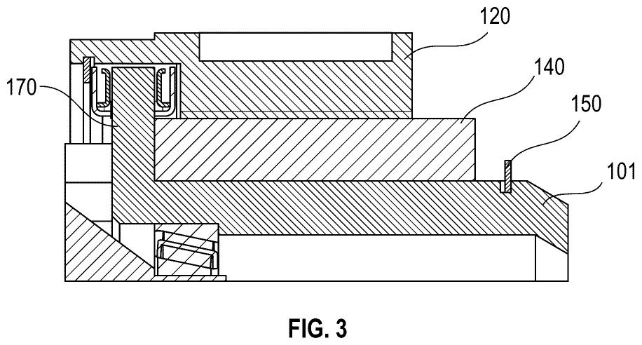

FIG. 3 is a partial longitudinal sectional view through the flange of the concentric bistable disconnect actuator system on the linking shaft showing the movable clutch provided on the first shaft. The movable clutch 140 is shown in the engaged position with the flange 170 serving as a stop for the movable clutch 140. Flange 170 also provides axial support of the rotor 120. Clutch stopper 150 stops the movable clutch 140 in the disengaged position.

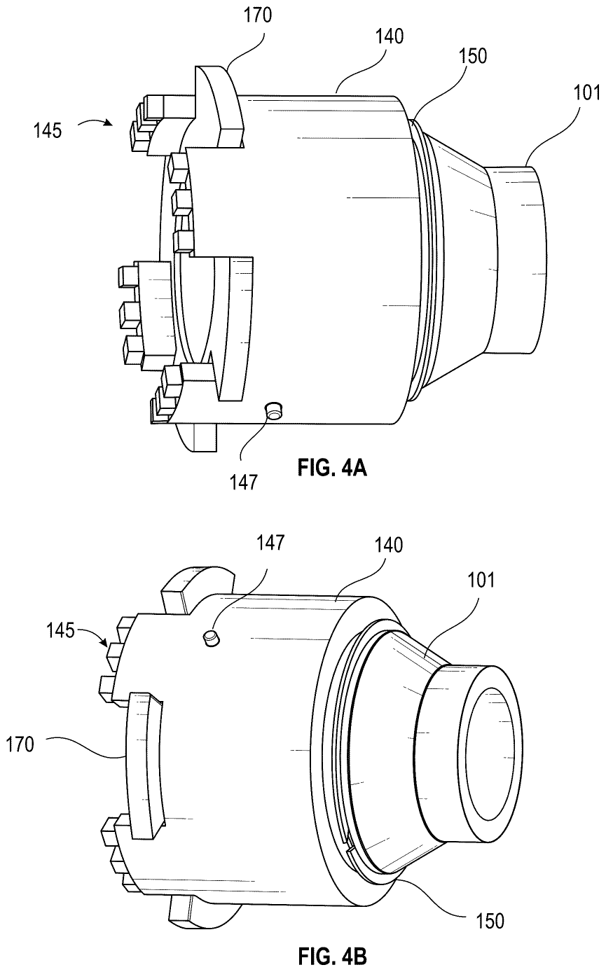

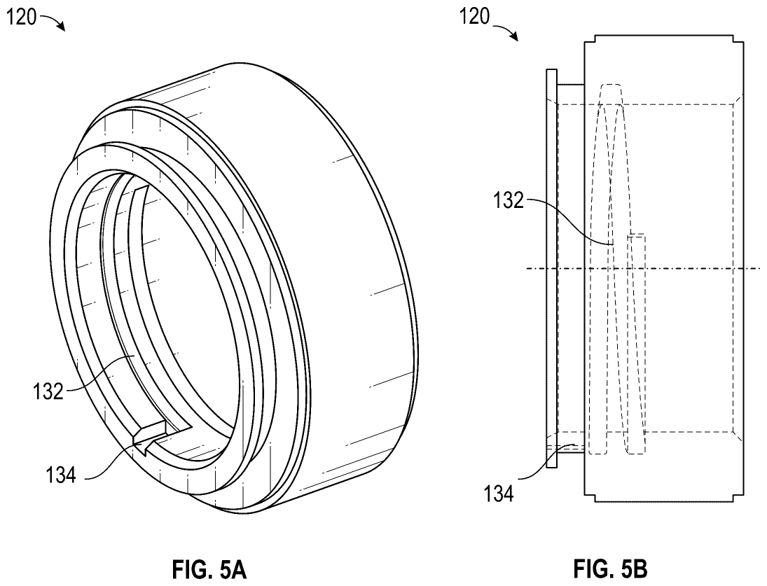

FIGS. 4A and 4B are perspective views showing the movable clutch provided on the first shaft. As shown, the movable clutch 140 is slidably mounted on first shaft 101 and includes dog teeth 145 and a flange 170. Cam follower 147 protrudes from the movable clutch to engage a groove in the rotor 120 as further discussed below.

FIG. 5A is a perspective view of a rotor and FIG. 5B is a side view of the rotor according to an example embodiment of the disclosure. The rotor 120 includes the groove 132 in which the cam follower 147 travels. As shown, groove 132 is in a spiral shape such that rotation of the rotor causes the follower 147 to slide the movable clutch 140 in a linear direction as discussed above. A straight portion 134 of the groove is parallel to the axis at an end of the spiral to cause the follower to dwell at an end of a rotation stroke for a stability. For example, when the follower 147 slides into the end portion 132 of the groove, it stays at the end of the spiral for a stability of the system. Dwells may be provided at both ends of the rotation stroke.

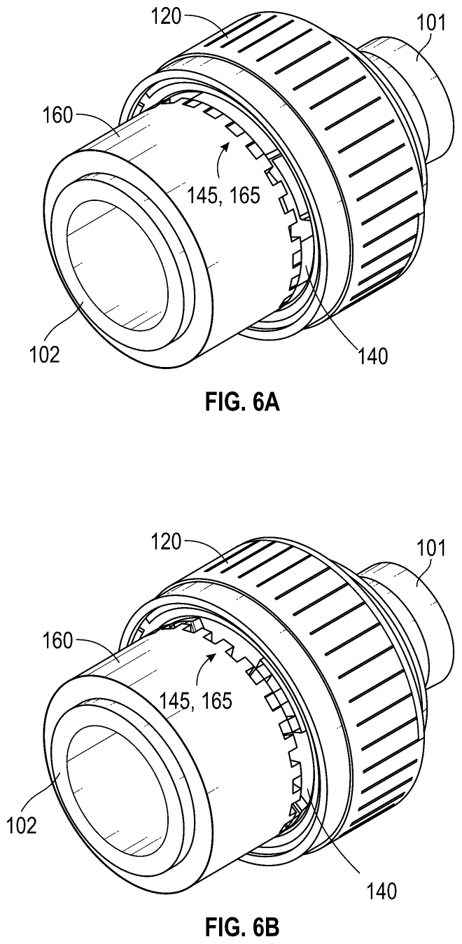

FIG. 6A is a perspective view of a portion where the movable clutch connects with the fixed gear. When the stator 110 is electrically energized, the rotor 120 rotates in a first direction and the cam mechanism 130 conveys the rotational movement of the rotor 120 into linear motion of the movable clutch 140, for example, a direction to engage the fixed gear 160 as shown in FIG. 6A. FIG. 6B is a perspective view of a portion where the movable clutch disconnects with the fixed gear. When the stator 110 is electrically energized reversely, the rotor 120 rotates in a second direction opposite to the first direction and the cam mechanism 130 conveys the rotational movement of the rotor 120, into a linear motion of the movable clutch 140, for example, a direction to disengage from the fixed gear 160 as shown in FIG. 6B.

In one embodiment, the movable clutch includes a dog clutch which is designed to have a complete tooth engagement to transfer torque between the movable clutch 140 and the fixed gear 160. If the top of both teeth are in contact, it creates the impact force in the system. A washer, such as a belleville washer, may be located between the dog clutch and the rotor to absorb the impact when the dog clutch mates peak-to-peak with the fixed gear 160.

In some embodiments, at least one spring preloaded ball can be provided between the dog clutch slider 140 and the rotor 120 to avoid unintentional rotation of the rotor. For example, the dog clutch slider collar can have two cavities to accommodate the preloaded ball at engaged and disengaged position. The spring loaded ball resistance torque should be higher than the rotor inertial torque under max dynamic acceleration. And the motor torque should be higher than the preload ball resistance torque.

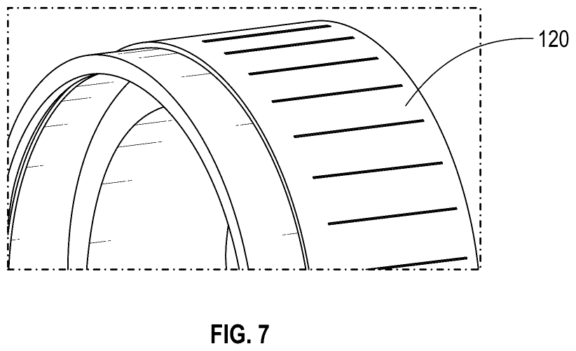

In some embodiments, the rotor 120 rotates along with dog clutch 140 and first shaft 101 and operates asynchronously with motor slip. When the stator coil energizes, as long as the rotation speed of the stator magnetic field is higher than the shaft speed the rotor 120 rotates and actuates the dog clutch 140 due to induction motor slip. In some embodiments, synchronous motor operation may be used. In such embodiments, rotor shaft speed is detected and a stator magnetic field rotation speed is applied in phase to actuate the dog clutch. If the synchronous motor has permanent magnet drag torque generated when the shaft rotates causing inefficiencies. FIG. 7 is a partial perspective view of a rotor according to an example embodiment. The rotor can be non-magnetic.

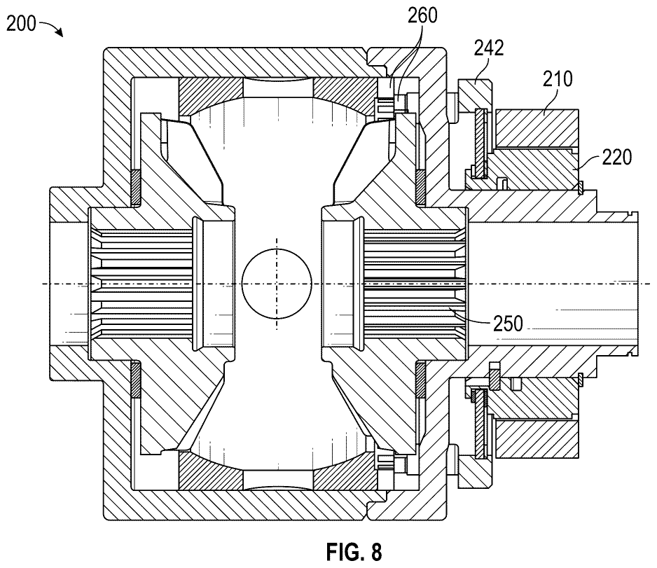

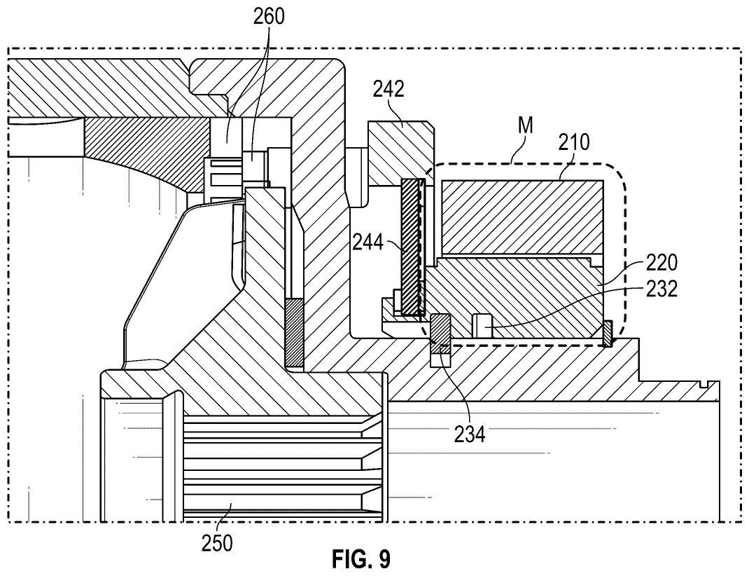

FIG. 8 is a longitudinal sectional view of a concentric bistable disconnect actuator system in a differential of a vehicle and FIG. 9 is an enlarged partial sectional view of the concentric bistable disconnect actuator system. The disconnect actuator system 200 and an axle of an automobile are concentric and the disconnect actuator system 200 connects and disconnects the axle from wheels when there is a decreased power demand during an operation of the vehicle.

As shown, an induction motor M includes a stator 210 which is stationary and fixed on an axle housing, and a rotor 220 which has a cam mechanism as discussed above. The cam mechanism includes a groove 232 on an inner diameter of the rotor 220 and a follower is implemented as a roller 234 preloaded in the groove 232. When the stator 210 is electrically energized, the rotor 220 rotates, and the roller 234 in the cam mechanism 230 moves along an axis of the stator 210. The axial motion of the rotor 220 actuates a sleeve 242 through a thrust plate 244 in a movable clutch 240 to connect and disconnect clutch teeth 260.

When the stator 210 is electrically energized, the rotor 220 rotates in one direction, for example, a forward direction. As the rotor 220 rotates forwardly, the roller 234 preloaded in the groove 232 causes the rotor 220 to move axially in a direction closer to the clutch tooth 260. The linear motion of the rotor 220 actuates the sleeve 242 through the thrust plate 244 to connect the clutch tooth 260.

When the stator 210 is electrically energized reversely, the rotor 220 rotates in the other direction, for example, a backward direction. As the rotor 220 rotates backwardly, the groove 232 pushes the roller 234 preloaded in the groove 232 to move axially in a direction further from the clutch tooth 260. The thrust plate 244 is an intermediate member between the sleeve 242 and the rotor 220. The clutch tooth 260 is on the sleeve 242 and a differential housing. The linear motion of the roller 234 actuates the sleeve 242 through the thrust plate 244 to connect and disconnect the clutch tooth 260. After connecting the clutch tooth 260, the energy is delivered to spline 250 through the differential axle of the housing.

A method to control the disconnect actuator system includes moving a first connecting part, which is rotatably connected to a first shaft connecting to wheels of the electric vehicle, axially by an actuation part through an engagement part; and connecting and disconnecting the first connecting part with a second connecting part, which is rotatably connected to a second shaft connecting to an axle of the electric vehicle.

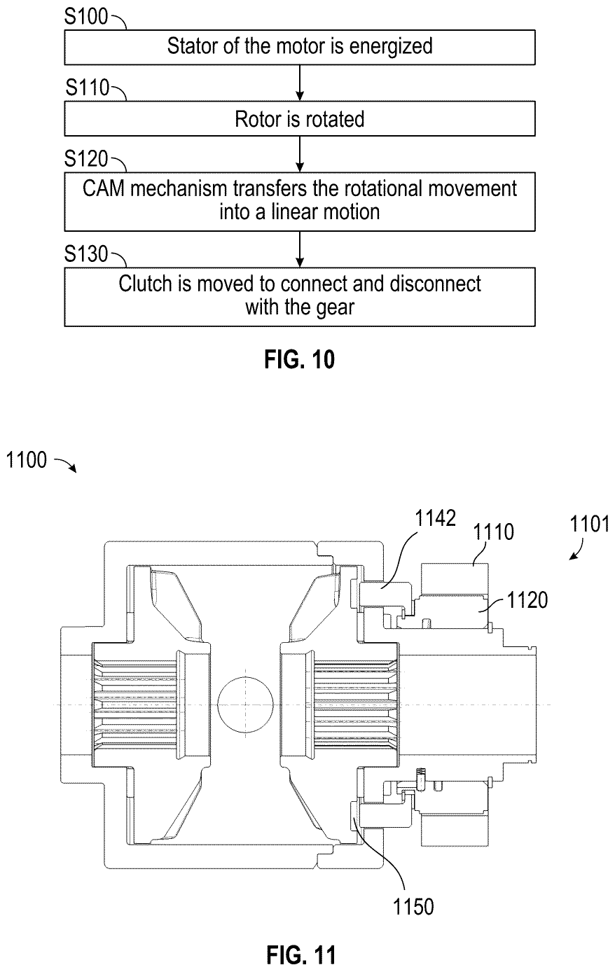

Next, FIG. 10 illustrates an exemplary flowchart for performing connecting and disconnecting the movable clutch from the fixed fear according to one aspect of the present application. The hardware description above, exemplified by any one of the structure examples, constitutes or includes specialized corresponding structure that is programmed or configured to perform the algorithm shown in FIG. 10.

As shown in FIG. 1, a concentric bistable disconnect actuator system on a linking shaft is controlled to connect and disconnect a clutch so that two separate shafts in the linking shaft, a first shaft and a second shaft, can be rotated together and rotated separately depending on whether they are linked by the actuator system.

In step 100, an induction motor rotatably placed on the first shaft is energized.

In step 110, the rotor in the induction motor is rotated in a direction. For example, when the rotor is positively energized, the rotor rotates in a forward direction. When the rotor is negatively energized, the rotor rotates in a backward direction.

In step 120, the cam mechanism transfers the rotational movement of the rotor into an axially linear motion of the movable clutch. For example, when the rotor rotates in a forward direction, the cam mechanism transfers the forward rotational movement of the rotor into a linear motion of the movable clutch in a direction closer to the fixed gear. When the rotor rotates in a backward direction, the cam mechanism transfers the backward rotational movement of the rotor into a linear motion of the movable clutch in a direction further from the fixed gear.

In step 130, the movable clutch moves to connect or disconnect with the fixed gear. For example, when the movable clutch moves in a direction closer to the fixed gear, the movable clutch is connected to the fixed gear, for example, by a dog clutch. When the movable clutch moves in a direction further from the fixed gear, the movable clutch is disconnected from the fixed gear.

As discussed above, the connection and disconnection of the movable clutch and the fixed gear switch the operation mode of the shafts and vehicles. For example, in step 130, when the movable clutch is connected with the fixed gear, a first shaft and a second shaft is linked in a linking shaft so that the first and second shafts are rotated together. When the movable clutch is disconnected from the fixed fear, the first shaft and the second shaft are not linked in the linking shaft, and each shaft rotates separately.

In other example, in step 130, when the movable clutch is connected with the fixed gear, the vehicle switches from the 2-wheel drive operation to the 4-wheel drive operation. When the movable clutch is disconnected from the fixed fear, the vehicle switches from the 4-wheel drive operation to the 2-wheel drive operation.

Actuation systems and methods disclosed herein may be used on a differential or link shaft. An induction motor may be a lead screw motor that produces linear movement from the rotation of a rotor. The induction motor includes a stator connected to an axle housing and an induction rotor mounted on a shaft. The induction rotor may be implemented as a cam profile groove on its inner diameter which transfers a rotational movement of a structure to a linear motion of another structure. A guide roller is preloaded into the groove from the shaft. When the stator is electrically energized, the rotor rotates, which moves the cam-roller mechanism axially. The axial motion of the rotor is used to push a sleeve in the disconnect clutch to connect and disconnect. The cam groove profile can dwell at the end of the stroke for a stability.

FIG. 11 is a longitudinal sectional view of a bistable actuator used as a differential locker according to one example embodiment of the present disclosure. The main function of the actuator 1100 in this context is connecting a differential housing to an axle side shaft gear. By rotational connection, the axle works as rigid shaft. As shown in FIG. 11, the actuator 1101 is configured to move engagement part 1142. Specifically, rotor 1120 rotates with CAM assistance to move the engagement part 1142 axially. Engagement part 1142 is rotatably fixed to a housing and moves axially to connect the differential housing to the side shaft gear. A pocket 1150 is provided is provided for the engagement part to connect the side gear.

The present application provides a bistable solution in which provides a stable condition in both connected and disconnected positions. Specifically, when an actuator is energized, an actuator is in a stable connected position, and once a power is cut off, the actuator moves back to a stable disconnected position. The bistable solution of concentric induction motor also works with a shaft disconnect system. The shaft disconnect system can include a stationary dog clutch and a movable dog clutch which are rotatably connected by spline to a first shaft and a second shaft, respectively. The cam groove profile (screw mechanism) between the rotor and the movable dog clutch moves the sleeve between the connected and disconnected positions. The stator is stationary and fixed on the axle housing. The stator has an electrical power supply. The rotor is positioned concentric/radially inward to the stator core. The rotor is coupled with a movable dog clutch by the cam groove profile (screw mechanism). The rotor is axially supported by the shaft flange using a thrust washer or needle bearing for efficiency.

When a concentric bistable disconnect is used in a linking shaft, a fixed dog clutch and a movable dog clutch are rotatably connected to each corresponding shaft. A cam or screw mechanism between a rotor and the movable dog slider moves the sleeve to engage and disengage its position.

This application also provides an actuation system for a hybrid/electric vehicle. A stator is stationary and is fixed on the axle housing with an electrical power supply. The rotor is positioned concentric/radially inward to the stator core. The rotor is coupled with a dog clutch slider by the cam mechanism or screw connection. Both fixed and movable dog clutches are rotatably connected to their respective shafts by spline. The rotor is axially supported by a shaft flange using a thrust washer or needle bearing on either side for efficiency.

When the induction motor stator energizes, the rotor rotates forward and engages the dog clutches by the barrel cam/screw mechanism. The dog clutches remain in the connected position due to a self-locking of the cam/screw mechanism.

When the stator energizes in the opposite direction, the rotor rotates in a reverse direction and disengages the movable dog clutch from the fixed dog clutch using the cam/screw mechanism.

Obviously, numerous modifications and variations of the present invention are possible in light of the above teachings. It is therefore to be understood that within the scope of the appended claims, the invention may be practiced otherwise than as specifically described herein.

1. A disconnect actuator system, comprising:
a first connecting part concentrically arranged about an axis and configured to move axially along the axis;
a second connecting part concentrically arranged about the axis and positioned adjacent to the first connecting part along the axis; and
an actuator concentrically arranged about the axis and positioned radially outside of the first connecting part, wherein the actuator comprises:
a rotating part concentrically arranged about the axis and configured to rotate about the axis relative to the first and second connecting parts, and
a converter configured to convert rotational movement of the rotating part into linear movement of the first connecting part such that the first connecting part can connect and disconnect with the second connecting part.

2. The disconnect actuator system according to claim 1, wherein the converter is a cam mechanism.

3. The disconnect actuator system of claim 2, wherein the cam mechanism comprises:
a cam groove provided in the rotating part and which extends circumferentially about the axis, and
a follower coupled to the groove and configured to move axially along the axis when the rotating part rotates about the axis.

4. The disconnect actuator system according to claim 1, wherein the actuator comprises:
a stator, and
a rotor disposed radially inward to the stator, wherein the cam groove is provided on a radially inner surface of the rotor.

5. The disconnect actuator system according to claim 4, wherein
the rotor is configured to rotate in one direction so that the first connecting part connects with the second connecting part, and
the rotor is configured to rotate in the other direction so that the first connecting part disconnects with the second connecting part.

6. The disconnect actuator system according to claim 5, wherein the first connecting part and the second connecting part are connected to each other by engagement of clutch teeth.

7. The disconnect actuator system according to claim 4, wherein the first connecting part comprises:
a thrust plate having a first end coupled to the converter; and
a sleeve coupled to a second end of the thrust plate, wherein the thrust plate and sleeve are configured to move axially when the rotating part is rotated.

8. The disconnect actuator system according to claim 1, further comprising:
a first shaft which defines the axis and rotates about the axis; and
a second shaft positioned adjacent to the first shaft along the axis and configured to rotate about the axis, wherein the first connecting part is coupled to the first shaft, the second connecting part is coupled to the second shaft, and the actuator is configured to connect and disconnect the first and second shaft with each other.

9. The disconnect actuator system according to claim 8, wherein the first shaft comprises a flange configured to stop axial movement of the first connecting part in a connected position of the first and second shaft.

10. The disconnect actuator system according to claim 1, further comprising a stop mechanism coupled to the first shaft and configured to stop axial movement of the first connecting part in a disconnected position of the first and second shaft.

11. A disconnect actuator system for an electric vehicle, comprising:
a first connecting part rotatably connected to a first shaft which rotates about an axis of the electric vehicle, wherein the first connecting part is configured to move axially along the axis;
a second connecting part, rotatably connected to a second shaft, which is connecting to an axle of the electric vehicle;
an actuation part
coupled with the first connecting part through an engagement part,
configured to move the first connecting part so that the first connecting part is connected and disconnected with the second connecting part,
being concentric with the first connecting part and the second connecting part, and
configured to rotate relative to the first and second connecting parts.

12. The disconnect actuator system according to claim 11, wherein the engagement part is a cam mechanism.

13. The disconnect actuator system according to claim 12, wherein the actuation part is a rotor disposed radially inward to the stator and including the engagement part.

14. The disconnect actuator system according to claim 13, wherein the cam mechanism comprises:
a circumferential groove in an inner diameter of the rotor, and
a roller preloaded in the groove and coupled to the first connecting part.

15. The disconnect actuator system according to claim 14, wherein
the rotor is configured to rotate in a first direction so that the first connecting part connects with the second connecting part, and
the rotor is configured to rotate a second direction opposite to the first direction so that the first connecting part disconnects with the second connecting part.

16. The disconnect actuator system according to claim 11, wherein
the first shaft is connected to one of rear wheels (RW) of the electric vehicle, and
the second shaft is connected to an Axle (secondary axle) and the other of the rear wheels (RW) of the electric vehicle.

17. A differential lock actuator system, comprising:
a first connecting part concentrically arranged about an axis and configured to move axially along the axis;
a second connecting part concentrically arranged about the axis and positioned adjacent to the first connecting part along the axis; and
an actuator concentrically arranged about the axis, wherein the actuator comprises:
a rotating part concentrically arranged about the axis and configured to rotate about the axis relative to the first and second connecting parts, and
a converter configured to convert rotational movement of the rotating part into linear movement of the first connecting part such that the first connecting part can connect and disconnect with the second connecting part.

18. The differential lock actuator system of claim 17, wherein
the first connecting part is rotatably connected to a first shaft which rotates about an axis of the electric vehicle,
the second connecting part is rotatably connected to a second shaft which is connected to an axle of the electric vehicle, and
wherein the actuator:
is coupled with the first connecting part through an engagement part,
is configured to move the first connecting part so that the first connecting part is connected and disconnected with the second connecting part,
is concentrically arranged with the first connecting part and the second connecting part, and
is configured to rotate relative to the first and second connecting parts.

19. The differential lock actuator system of claim 17, wherein the actuator comprises:
a stator, and
a rotor disposed radially inward to the stator, wherein a cam groove is provided on a radially inner surface of the rotor.

20. The differential lock actuator system of claim 19, wherein
the rotor is configured to rotate in one direction so that the first connecting part connects with the second connecting part, and
the rotor is configured to rotate in the other direction so that the first connecting part disconnects with the second connecting part.
